(19) United States
(12) Patent Application Publication
(10) Pub. No.: US 2018/0187790 A1
(43) Pub. Date: Jul. 5, 2018

(54) ELECTRONIC TORQUE LIMIT SWITCH WITH INTEGRATED INTERPOSING CONTROLLER

(71) Applicant: Bray International, Inc., Houston, TX (US)

(72) Inventor: Jim Schmidt, Houston, TX (US)

(21) Appl. No.: 15/863,757

(22) Filed: Jan. 5, 2018

Related U.S. Application Data
(60) Provisional application No. 62/442,841, filed on Jan. 5, 2017.

(51) Int. Cl. F16K 31/04; F16K 37/00; G05D 17/02; G05B 15/02

(52) U.S. Cl. CPC F16K 31/046; G05B 15/02; G05D 17/02; F16K 37/0083

(57) ABSTRACT

An electronic torque limit switch, limiting excess torque in a valve actuator, and/or optimizing the actuation of a valve having a motor configured for driving a valve between an open direction and a closed direction. A threshold current of the motor is set. An ongoing current of the motor is monitored. The ongoing current is compared to the threshold current. Power to the motor may be disconnected when the ongoing current exceeds the threshold current. Conjunctively or disjunctively an initial threshold torque for the valve is set. A number of operational cycles of the valve are monitored. And, the threshold of torque is adjusted to another threshold of torque via correlating the number of operational cycles of the valve to a known database of torque characteristics for the valve.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

### Technical Field

The subject matter generally relates to systems and techniques in the field of valve actuators. Monitoring, identifying, and controlling the torque level of the valve improves the usable lifetime as well as reduces damage to the valve and valve actuator.

Valves may be used in a number of applications to control the flow of fluids through piping systems. There are several different types of valves used for controlling flow such as ball valves, gate valves, butterfly valves, needle valves, check valves, and the like. Ball valves, butterfly valves, needle valves and gate valves may be actuated with an actuator, such as an electric or pneumatic actuator, a manual hand wheel, or manual lever between the open and closed position.

As mentioned above, preventing excessive torque to the valve system is important as said excess torque can cause damage to the valve system. Further, it is also necessary to prevent a condition recognized as “run through” where the inertia of the valve motor prevents the instantaneous reversal of the motor resulting in the motor continuing to operate in the same direction. In the past, limitation of excess torque may have been accomplished through mechanical or electromechanical means, such as torque limit switches, which may be prone to user error. Moreover, replacing or repairing the mechanical parts of conventional torque limit switches may require extensive downtime for the valve system. Therefore, a need exists for an actuator which accurately monitors, identifies, communicates, and manipulates the torque level of the valve.

### BRIEF SUMMARY

An electronic torque limit switch, limiting excess torque in a valve actuator, and/or optimizing the actuation of a valve having a motor configured for driving a valve between an open direction and a closed direction. A threshold current of the motor is set. An ongoing current of the motor is monitored. The ongoing current is compared to the threshold current. Power to the motor may be disconnected when the ongoing current exceeds the threshold current. Conjunctively or disjunctively an initial threshold torque for the valve is set. A number of operational cycles of the valve are monitored. And, the threshold of torque is adjusted to another threshold of torque via correlating the number of operational cycles of the valve to a known database of torque characteristics for the valve.

### BRIEF DESCRIPTION OF THE FIGURES OF THE DRAWINGS

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts a perspective schematic view of an exemplary embodiment of an electronic torque limit switch with integrated interposing controller as part of an electronics module within an actuator.

FIG. 2 depicts a perspective internal view of an alternate exemplary embodiment of an actuator showing the current sensor of the electronic torque limit switch.

FIG. 3 depicts a perspective schematic view of an exemplary embodiment an electronic torque limit switch with integrated interposing controller implemented as part of an electronics module.

FIG. 4 depicts a schematic of a piping system having a valve with an actuator and a valve position indicator.

### DETAILED DESCRIPTION OF THE EXEMPLARY EMBODIMENT(S)

The description that follows includes exemplary apparatus, methods, techniques, and instruction sequences that embody techniques of the inventive subject matter. However, it is understood that the described exemplary embodiments may be practiced without these specific details.

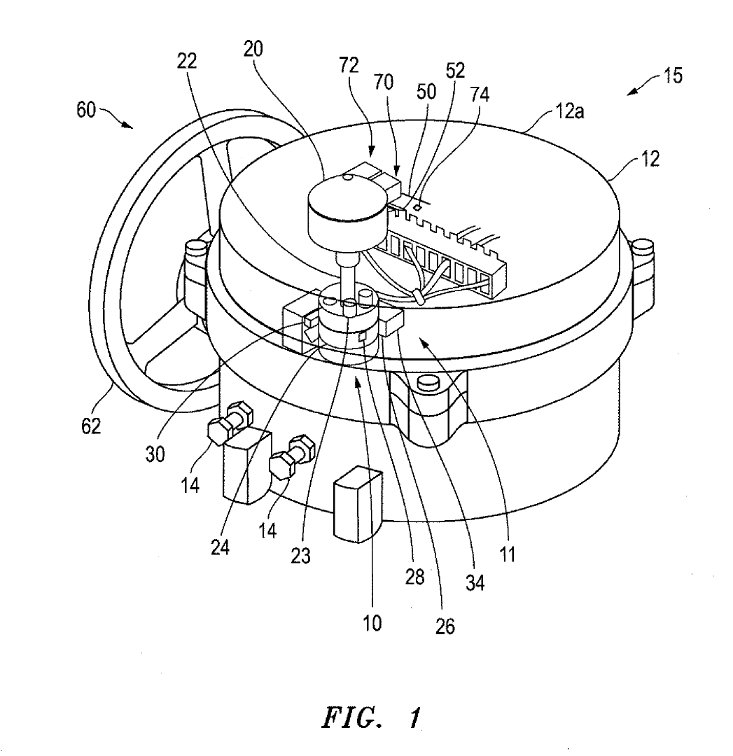

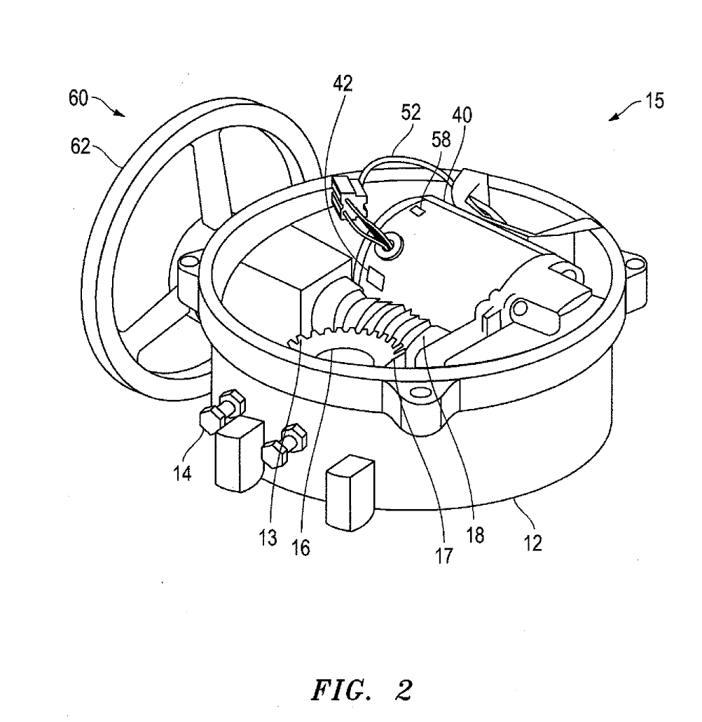

FIG. 1 depicts a schematic view of one exemplary embodiment of an electronic torque limit switch 70 with integrated interposing controller 72 as part of an electronics module 50 within an actuator 15. FIG. 2 depicts an internal view of the actuator 15 having the current sensor 58 of the electronic torque limit switch 70 on the motor 40. The actuator 15 may actuate a rotary type valve (not shown), which for example, may be a butterfly valve in which the valve member is a disc generally rotatable a quarter turn between an open and a closed position. However, the actuator 15 may be adapted to rotate other types of valves, including, but not limited to ball valves, gate valves, check valves and/or needle valves. The actuator 15 has a housing 12, with a removable cover 12A, said housing 12 adapted to be mounted on the valve, a drive system including a quadrant gear or worm gear 16 (shown in FIG. 2) mounted for rotation in the housing 12, and adapted to be connected to the valve stem (not shown) of the valve in order to impart rotation thereto, a reversible electric motor 40 in the housing 12 having an motor or output shaft (not shown), a worm 18 mounted for rotation and limited reciprocation within the housing 12, and a means connecting the motor shaft to the worm 18 for rotating the worm 18 and connecting the worm 18 to the worm gear 16 for rotating the worm gear 16 and thus the valve stem in opposite rotational directions to open and close the valve responsive to the operation of the motor 40. The housing 12 may include an inner wall 11 upon which the electronics module 50 is disposed or otherwise connected or mounted to. The electronics module 50 and/or the microcontroller 56 may be in data connection with the motor 40 and, upon removal of cover 12A, may also allow user or operator input to direct the motor 40 to drive in one direction or a reverse direction to open or close the valve. The data communication between the electronics module 50 and the motor 40 may be accomplished through wires 52, or wireless communication.

The motor 40 may further include an electronic revolution counter 42, which is configured to detect the passing of motor gear teeth or other means to detect the revolutions of the motor 40. The electronic revolution counter 42 may be a Hall-Effect type of sensor and may also be in data communication with the electronics module 50 and microcontroller 56.

The quadrant gear or worm gear 16 is connectable to the valve stem so as to rotate the valve between open and closed positions. The worm gear 16 has a partial circle of teeth 13 configured for engaging the worm 18. Further, the worm gear 16 has shoulders 17 at opposite ends of the partial circle of teeth 13. Mechanical travel limits or stops 14 are mounted on and extend into the housing 12 in position to be engaged by the shoulders 17 to prevent over travel of the worm gear 16 in either direction. More particularly, the mechanical travel limits or stops 14 may be bolts threadably connected through holes in one side of the housing 12 to allow movement of their surfaces to positions for engagement by the shoulders 17 in different rotational positions of the worm gear 16. The mechanical travel limits or stops 14 are held in place by nuts which permit the user of the actuator 15 to adjust the inner ends, and thus the positions at which the worm gear 16 and thus the valve stem would be stopped in an emergency situation—i.e., in which the actuator 15 was otherwise free to continue to rotate the valve stem beyond its desired open or closed position.

The actuator 15 may further include an electronic actuator position encoder 10. The electronic actuator position encoder 10 may have one or more cam rings 24 which are rotatable in response to rotation of the valve stem between opened and closed positions of the valve. The cam rings 24 may be one or more axially spaced plates, which surround a shaft 22 which is rotatable with the valve stem. In one exemplary embodiment, the cam rings 24 may be mounted on a position indicator shaft 22 of a valve position indicator 20, which is connected to the valve stem. The position indicator shaft 22 may extend through the inner wall 11 to connectably engage the valve stem through the worm gear 16. However, in alternate exemplary embodiments, the cam rings 24 may not necessarily be in connection with the position indicator shaft 22, but any shaft 22 which rotates in response to movement of the valve stem. Each cam ring 24 has an outer surface 26, upon which one or more magnets or detectable items 28 may be attached. Alternatively, the magnets 28 may be integral to, behind, or under the outer surfaces 26 of the cam rings 24. Further, the cam rings 24 may be adjusted to different rotational positions by one or more knobs 23 at one end of the cam rings 24. The knobs 23 are readily accessible for manual manipulation when the cover 12A of the housing 12 is removed.

One or more sensors 30 may be part of the electronic position encoder 10 in the housing 12 in position to sense or detect the detectable items or magnets 28 on the cam rings 24. The sensors 30 may be a Hall-Effect type sensor or any similar sensing device, and may be in data communication with the electronics module 50 and microcontroller 56, whether wirelessly or through wires 52.

Optionally, the sensors 30 may also be in data communication with a feedback potentiometer 34. While the feedback potentiometer 34 may be physically separate from the sensors 30 in one exemplary embodiment (as seen in FIG. 1), in alternate exemplary embodiments, the feedback potentiometer 34 may be a unitary unit with the sensor 30, or may be unitary with the electronics module 50. The feedback potentiometer 34, in addition to being in data communication with the sensors 30, may also be in data communication with the electronics module 50.

While the detectable items 28 are primarily described within the present disclosure as magnets 28, it is to be appreciated that other characteristics, substances, or signals may be installed upon the cam surface 26 that may be detected, sensed, discerned, measured, identified, engaged by, or otherwise observed by an appropriate corresponding sensor 30.

Operation of the motor 40 in one direction will in turn rotate the worm 18 and worm gear 16, and thus the valve stem and cam rings 24 in one direction, while operation of the electric motor 40 in the opposite direction will in turn rotate the valve stem and cam rings 24 in the opposite direction, thus selectively moving the valve between opened and closed positions.

The actuator 15 may further include a manual override system 60 having a handwheel 62. The handwheel 62 may be selectively engageable with the actuator 15 to operate the valve upon deactivation of the motor 40. The manual override system 60 may further include a means for automatically deactivating the motor 40, the further details of which are disclosed in U.S. Pat. No. 6,003,837, which is herein incorporated by reference in its entirety.

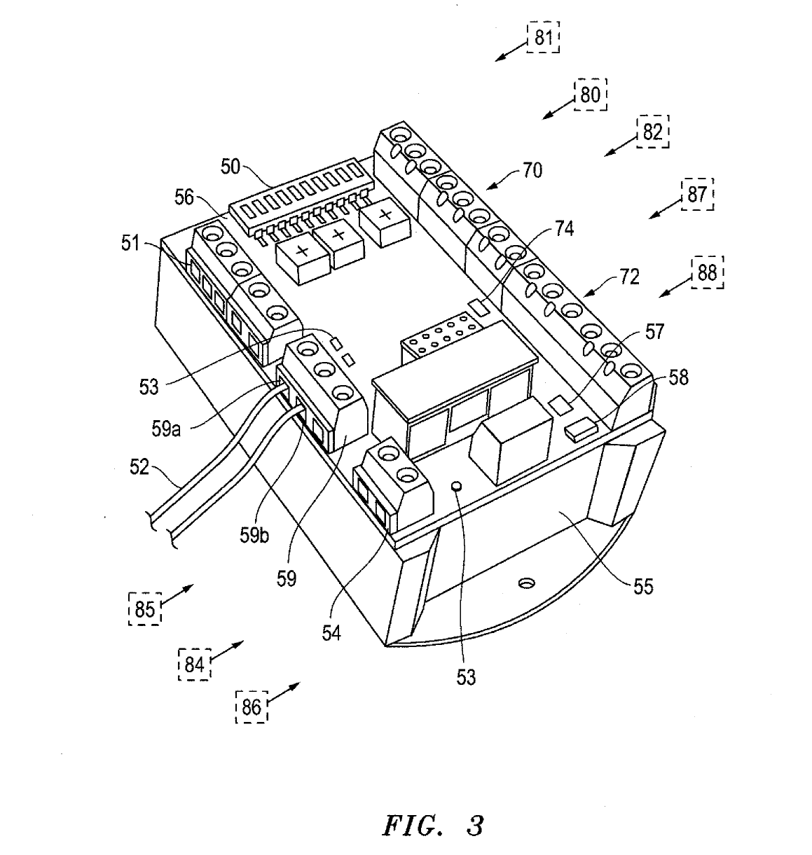

FIG. 3 depicts a schematic view of an exemplary embodiment an electronic torque limit switch 70 with integrated interposing controller 72 implemented as a part of the electronics module 50. The electronics module 50 includes at least a power supply circuit 54, a microcontroller 56, current sensing electronics or current sensor 58, and motor power control electronics 59, all of which may be disposed on or within a casing 55. The casing 55 may be mounted to the actuator 15, for example, on the inner wall 11 of the actuator 15. Although the power supply circuit 54, microcontroller 56, current sensing electronics 58, motor power control electronics 59 and connections 51 are illustrated on or within the casing 55, they may also be located external to the electronics module 50, so long as they are in data communication with the electronics module 50. Further, the electronics module 50 may have input or output connections, terminal connections or connections 51 and indicator features 53. The wires 52 may be inserted into connections 51 to communicate data or information back and forth between the actuator 15 and the electronics module 50. The input connections 51 and wires 52 may not all be the same kind of connections and wires, and may depend on the particular needs of the connection 51 (e.g. whether to supply power or to transmit data). Indicator features 53 may be, by way of example only, LED lights to demonstrate various conditions (e.g. an open, closed or partial valve position, or whether the motor 40 is operating in an open or a closed direction).

The power supply circuit 54 may be configured to supply power to not only the electronics module 50 when connected with wires 52, but may also supply power to the actuator 15. Further, indicator features 53 may be used to display or communicate when power is flowing through power supply circuit 54.

The current sensing electronics or current sensor 58 may be any type of commercially available current sensor configured to be able to continuously monitor the current 80 of the motor 40. The current sensing electronics 58 provide feedback regarding the present or ongoing current 80 status of the motor 40 to the microcontroller 56. The current sensing electronics 58 may be located on the casing 55 of the electronics modules 50, as illustrated in FIG. 3, or the current sensing electronics 58 may optionally be located on or incorporated with the motor 40, as seen in FIG. 2.

The motor power control electronics 59 may contain connections 51 implemented as input connections 59a and 59b, wherein connection 59a may be configured to direct and drive the motor 40 and thus the valve in an open direction, and connection 59b may be configured to direct and drive the motor 40 and thus the valve in a closed direction. The motor power control electronics 59 is also in data communication with the microcontroller 56. In addition, the microcontroller 56 or the operator of the system may direct the motor power control electronics 59 to supply/activate or cease/deactivate power to the motor 40.

The electronics module 50 and its components, such as the microcontroller 56, are generally implemented as electronic circuitry and processor-based computational components controlled by computer instructions stored in physical data storage components 74, including various types of electronic memory and/or mass-storage devices. It should be noted, at the onset, that computer instructions stored in physical data storage devices 74 and executed within processors comprise the control components of a wide variety of modern devices, machines, and systems, and are as tangible, physical, and real as any other component of a device, machine, or system. Occasionally, statements are encountered that suggest that computer-instruction-implemented control logic is “merely software” or something abstract and less tangible than physical machine components. Those familiar with modern science and technology understand that this is not the case. Computer instructions executed by processors must be physical entities stored in physical devices. Otherwise, the processors would not be able to access and execute the instructions. The term “software” can be applied to a symbolic representation of a program or routine, such as a printout or displayed list of programming-language statements, but such symbolic representations of computer programs are not executed by processors. Instead, processors fetch and execute computer instructions stored in physical states within physical data storage devices 74. Similarly, computer-readable media are physical data storage media 74, such as disks, memories, and mass-storage devices that store data in a tangible, physical form that can be subsequently retrieved from the physical data storage media 74.

The microcontroller 56 accesses and uses a variety of different types of stored, recorded, or received information, data, records, and inputs, 82 including, optionally, user/operator input, in order to generate output controls or commands that may trigger or change processes of the actuator 15 and the electronics module 50, such as the power supply circuit 54, current sensing electronics 58, motor power control electronics 59, indicator features 53, motor 40, the valve, and/or other components of the actuator 15 (including the electronic position encoder 10 and valve position indicator 20). Such information, records or data, 82 whether received to the microcontroller 56 by user-input or feedback from components of the actuator 15, includes at least: current measurements as sensed from the current sensing electronics 58, historical data as recorded by the microcontroller 56 on a physical data storage media 74, status of the power supply to the actuator 15 and the electronics module 50, revolutions per minute (RPMs) from the electronic revolution counter 42, magnet or other detectable item 28 detection from the sensors 30, feedback regarding the detectable items 28 from the feedback potentiometer 34, whether the manual override system 60 and/or handwheel 62 is engaged, torque or torque measurements 84, torque thresholds or limits 85, amongst others. Additional information or records 82 used by the microcontroller 56 in its algorithms may include one or more stored control schedules, known databases 88 of mechanical and torque operating characteristics for a particular valve, immediate control inputs received through a control or display interface, and data, commands, and other information received from remote data-processing systems, including cloud-based data-processing systems. Further, the microcontroller 56 may monitor data feedback and/or input for the actuator 15 to automatically adjust to maintain a status quo for a feature, component or status of the valve or actuator 14. By way of example only, the microcontroller 56 may monitor and record a number valve open cycles, closed cycles 86 (i.e. number of operational cycles 86) and torque level 84 into the physical data storage component 74 of the microcontroller 56, and adjust the threshold current accordingly to allow for a constant level torque output throughout the valve's life. This history and data 82 stored by the physical data storage component 74 may be further used to troubleshoot, maintain, and repair the actuator 15 or the valve by the operator or manufacturer of the system, or by the microcontroller 56 itself. In addition to generating control output to manipulate the actuator 15 and the electronics module 50, such as the power supply circuit 54, current sensing electronics 58, motor power control electronics 59, indicator features 53, motor 40, the valve and/or other aspects of the actuator 15 (including the electronic position encoder 10 and valve position indicator 20), the microcontroller 56 may also provide a graphic or display interface that allows users/operators to easily input controls for valve position manipulation and recordation, valve speed, power input/output, adjusting torque levels, and may also provide output and information to remote entities, other microcontrollers, and to users through an information-output interface.

When the electronic torque limit switch 70 with integrated interposing controller 72 is operating in the on/off, open/close or non-modulating mode, the AC line voltage is connected to an input connection 51 of the electronics module 50 (and/or motor power control electronics 59). The connection 59a drives the motor 40 and the valve in the open direction and another connection 59b drives the motor 40 and the valve in the close direction. The indicator features 53 may display, by way of example only, a lit-up green LED, when the motor 40 is operating in the open direction, and a lit-up red LED, when the motor 40 is operating in the close direction.

During operation of the valve system, the state of the present, ongoing current 80 supplied to motor 40 is monitored by the current sensing electronics or current sensor 58. An initial current threshold 81 or threshold limit of torque 85 is set by first subjecting the actuator 15 to a known torque 87. At this known torque level 87, an input device or button 57 on the electronics module 50 or electronic torque limit switch 70 is engaged to communicate to the microcontroller 56 to record the current 80 as is measured or detected by the current sensing electronics 58 or present operating torque 84. The recorded current 80 for that operating direction is recorded as a record 82 by the physical data storage 74 of the microcontroller 56 and used as a reference. If the motor 40 exceeds the set or known current threshold 81, the power to the motor 40 will be disconnected by the microcontroller 56 and/or the motor power control electronics 59. This is important, when, for example, one wishes to avoid over-torqueing the valve when the valve is at an optimal torque for the “closed” position.

The motor 40 may exceed the set current threshold 81 when the valve encounters excessive torque, as for example when there is an obstruction in the line resulting in resistance to rotation to be transmitted through the worm 18. When excessive torque is encountered, the microcontroller 56 and the motor power control electronics 59 will cease power to or otherwise deactivate the motor 40 to prevent or reduce damage to the valve and actuator 15. The microcontroller 56 may further communicate data to indicator features 53 to indicate, demonstrate or otherwise communicate to the operator of the system that excessive torque has been encountered. Further, as the parts, surfaces, seats or gears of the valve wear, degrade or de-rate over time (i.e. wear of valve/actuator mechanical components 100 causes an increase of the operating torque over time), the microcontroller 56 may automatically adjust or compensate to allow for increased torque tolerance or an increase in operating torque 84 and thus set a higher current threshold 81 or a higher threshold torque 85 before the motor 40, actuator 15, and valve are shut off to maintain the same output torque. By implementation of an algorithm, changes in current 80 or operating torque 84 over time may be recorded and correlated to changes in output torque required for optimal function of the actuator 15. By way of example only, in an exemplary embodiment of an electronic torque limit switch 70, the electronics module 50 may adjust the calibrated torque limits, initial torque threshold, 85 or initial current threshold 81 to compensate for this increase in operating torque 84 by monitoring the number of operational cycles 86 of the valve correlated/compared to a known database 88 of mechanical torque operating characteristics. This known database 88 may be stored internally within the electronics module 50 and/or microcontroller 56 (e.g. on physical storage 74), or such data of mechanical torque operating characteristics may be stored and retrieved externally (such as, e.g. from the internet or cloud).

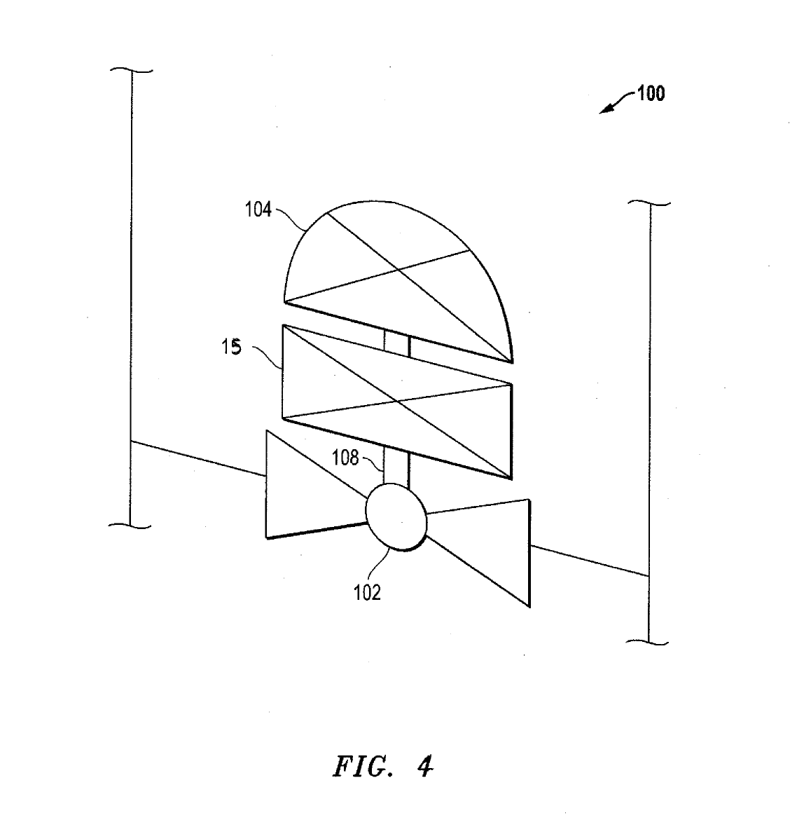

As known to one having ordinary skill in the art the valve/actuator mechanical components 100 are contained in a valve 102 and/or actuator 15 (and/or valve position indicator 104). FIG. 4 depicts a schematic view of a piping system having a valve 102 with an optional valve position indicator 104 according to an embodiment. The piping system may be any suitable piping system that requires the control of flow within the piping system. The valve 102 may have an actuator 15 configured to move the valve 102 between an open and a closed position. The actuator 15 may be any suitable actuator including, but not limited to, a pneumatic actuator, a hydraulic actuator, an electric actuator, and the like. The actuator 15 may have an actuator shaft 108 configured to manipulate, e.g., the valve disc, ball, etc., as the valve 102 moves between the open and closed position. The actuator shaft 108 may be configured to move the valve 102 between the open and closed position, or be a separate shaft that moves as the valve 102 moves between the open and closed position.

Further, the electronics module 50 may include an interposing function when the motor 40 is powered in one direction and then is connected to operate in the opposite direction through the integrated interposing controller 72 functions of the microcontroller. When such an event is encountered, the interposing function of the microcontroller 56 may force a delay before allowing the actuator 15 to operate. This delay may be, for example a one second delay, but may also be a longer or shorter delay as determined by the operator of the valve system. The delay prevents a condition recognized as “run through” where the inertia of the motor 40 prevents the instantaneous reversal of the motor 40 resulting in the motor 40 continuing to operate in the same direction.

While operating in the modulating mode, the modulating electronics module 50 may have the current sensing electronics 58 included.

Further, the electronic torque limit switch 70 with integrated interposing controller 72 and microcontroller 56 may also work in connection with an electronic position encoder 10 to calibrate the position of the valve and torque level 84 with feedback supplied to the microcontroller 56. As the microcontroller 56 may identify when a valve is in a closed or open position based on feedback from the position encoder 10 and the identification of the torque 84 or current 80 from the current sensing electronics 58, the microcontroller 56 may use the data regarding the torque 84 or current 80 to compare and calibrate a desired position of the valve, and monitor and manipulate the actual position as well. The microcontroller 56 may also be utilized with an exemplary embodiment of the position encoder 10 having multiple sensors 30 to set up and identify the closed and open position of the valve, wherein the microcontroller 56 may identify the closed or open position of the valve based on monitoring torque 84 or monitoring current 80; following that, the operator may adjust the cam rings 24 through knobs 23 accordingly.

The teachings and disclosure including, the specifications and drawings, of U.S. Pat. No. 9,546,742 and International/PCT Publication No. WO 2011/143598 are hereby and herein incorporated by reference and intended to be incorporated by reference for purposes of this disclosure.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method for optimizing the actuation of a valve, comprising the steps of:
setting an initial threshold of torque for the valve;
monitoring a number of operational cycles of the valve; and
adjusting the initial threshold of torque to a second threshold of torque.

2. The method of claim 1, further comprising the step of increasing an operating torque of the valve over time.

3. The method of claim 2, further comprising the step of correlating the number of operational cycles of the valve to a known database of torque characteristics for the valve.

4. The method of claim 3, wherein said step of correlating the number of operational cycles of the valve to a known database of torque characteristics for the valve further comprises the known database of torque characteristics for the valve correlating according to increased wear of mechanical components by use over time.

5. The method according to claim 3, wherein the step of setting the initial threshold of torque for the valve comprises the step of setting a threshold current for a motor of the valve.

6. The method of claim 5, further comprising the steps of:
monitoring an ongoing current of the motor;
comparing the ongoing current and the threshold current; and
disconnecting power to the motor when the ongoing current exceeds the threshold current.

7. The method of claim 6, wherein the step of setting a threshold current of the motor comprises the steps of:
subjecting the actuator to a known torque; and
recording a present current as the threshold current.

8. The method of claim 2, wherein the step of increasing an operating torque of the valve over time further comprises the step of determining a change in the torque over time.

9. A method for limiting excess torque in a valve actuator having a motor configured for driving a valve between an open direction and a closed direction, comprising the steps of
setting a threshold current of the motor;
monitoring an ongoing current of the motor;
comparing the ongoing current and the threshold current; and
disconnecting power to the motor when the ongoing current exceeds the threshold current.

10. The method according to claim 9, further comprising the steps of
directing the motor to drive in a first direction;
then directing the motor to drive in a second direction; and
delaying the motor from driving the motor in the second direction before driving the motor in the second direction.

11. The method according to claim 10, further comprising the step of preventing inertia of the motor from preventing instantaneous reversal of the motor.

12. The method according to claim 11, wherein the step of setting the threshold current of the motor comprises the steps of
subjecting the valve actuator to a known torque; and
recording a present current as the threshold current.

13. The method according to claim 11, wherein the step of setting the threshold current of the motor comprises the steps of
monitoring data related to the valve or the valve actuator;
recording a current as the threshold current which maintains an output torque for optimal function of the valve or the valve actuator.

14. The method according to claim 11, wherein the step of setting the threshold current of the motor comprises the steps of:
monitoring a number of operational cycles of the valve actuator; and
recording an adjusted current as the threshold current based on the number of operational cycles of the valve actuator correlated to a database of known mechanical torque operating characteristics.

15. The method according to claim 10, wherein the step of delaying the motor comprises delaying the motor for one second.

16. An electronic torque limit switch for a valve actuator having a motor configured for driving a valve between an open direction and a closed direction, comprising
a sensor configured to monitor a present current of the motor;
a motor power control electronics configured to supply and cease power to the motor; and
a microcontroller in data communication with the sensor and the motor power control electronics, wherein the microcontroller contains a record of a threshold current.

17. The electronic torque limit switch according to claim 16, wherein the motor power control electronics further comprises
a first connection configured to drive the motor in the open direction; and
a second connection configured to drive the motor in the closed direction.

18. The electronic torque limit switch according to claim 16, further comprising an input device in data communication with the microcontroller, wherein the input device is configured to record the threshold current onto the microcontroller.

19. The electronic torque limit switch according to claim 16, wherein the microcontroller is configured to compare the present current and the threshold current.

20. An electronics module for a valve actuator having a motor configured for driving a valve between an open direction and a closed direction comprising
a microcontroller located on the electronics module;
a current sensor in data communication with the microcontroller; and
a motor power control electronics in data communication with the microcontroller, wherein the motor power control electronics is configured for controlling power to the motor.
